(19) United States
(12) Patent Application Publication
(10) Pub. No.: US 2007/0189377 A1
(43) Pub. Date: Aug. 16, 2007

(54) Data processing apparatus

(75) Inventors: Andrew Robert Taylor, Brighton (GB); Ian McLean, Surrey (GB)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY UNITED KINGDOM LIMITED, Weybridge (GB)

(21) Appl. No.: 11/378,336

(22) Filed: Mar. 20, 2006

(30) Foreign Application Priority Data
Apr. 22, 2005 (GB) 0508201.1

(51) Int. Cl. H04B 1/66

(52) U.S. Cl. 375/240

(57) ABSTRACT

A method and apparatus for modifying a compression encoded video sequence representing a video image are described. The compression encoded video sequence includes a group of pictures comprising an intra-encoded picture and at least one inter-encoded picture, the inter-encoded picture comprising a plurality of image blocks. At least one of the image blocks has a motion vector representing a displacement of the image block with respect to a reference image block in another picture in the group of pictures, and a difference signal representing a difference between the image block and the reference image block. The method comprises the steps of detecting, for each group of pictures, the inter-encoded pictures within the video sequence, extracting the image blocks from the detected inter-encoded pictures, compressing at least a portion of the extracted image blocks to form compressed image block data, and inserting replacement image blocks and the compressed image block data into the video sequence to replace the extracted image blocks. The replacement image blocks each have a motion vector of value zero and a difference signal of value zero. By providing replacement picture data which represents replacement image blocks having a motion vector of value zero and a difference signal of value zero, sets the inter-encoded pictures of the modified video sequence to display, when decoded, the same image as that displayed on the previous intra-encoded picture, thereby providing a form of removable (washable) impairment such as a visible watermark.

### FIELD OF THE INVENTION

The present invention relates to a method and apparatus for modifying a video sequence, a method and apparatus for removing modifications made to a modified video sequence, an information signal and a computer program. In some embodiments the modification may introduce a visible watermark.

### BACKGROUND OF THE INVENTION

It is known to provide a watermark in video, audio, audio/visual and/or other information signals. The watermark is often provided to check the origin of the information signal and/or to identify the owner or other persons associated with the information signal. A watermark may be perceptible or hidden, however, a visible watermark can be used as a way of protecting the information signal by degrading it in a visible way, such as by overlaying a video image with a logo.

Although visible watermarks are intended to provide some degradation of the video sequence by obscuring a portion of at least some image pictures within the sequence, the use of watermarking on an inter-encoded video sequence, that is a video sequence in which some image pictures are encoded with reference to other video pictures, tends to result in undesirable distortion of both the image and the watermark. This is due to the motion compensation used in encoding methods such as MPEG2 to compress the video stream.

In circumstances where the intention of modifying a video sequence is to enable the viewer to appreciate the content of a video sequence, and to see the quality of video images within the sequence, without providing fully usable content, it is desirable to provide some modification of the video sequence, but without resulting in the undesirable distortion of both the image and the watermark.

### SUMMARY OF THE IVNENTION

An object of the present invention is to provide improved methods of modifying compression encoded video images, to the effect the encoded video images are adapted in a way which allows re-creation of the original video images. Another object of the present invention is to provide improved methods of visibly watermarking compression encoded video images.

According to one aspect of the present invention, there is provided a method of modifying a compression encoded video sequence representing a video image. The compression encoded video sequence includes groups of pictures comprising an intra-encoded picture and at least one inter-encoded picture, the inter-encoded picture comprising a plurality of image blocks. At least one of the image blocks has a motion vector representing a displacement of the image block with respect to a reference image block in another picture in the group of pictures, and a difference signal representing a difference between the image block and the reference image block. The method comprises the steps of detecting, for each group of pictures, the inter-encoded pictures within the video sequence, extracting the image blocks from the detected inter-encoded pictures, compressing at least a portion of the extracted image blocks to form compressed image block data, and inserting replacement image blocks and the compressed image block data into the video sequence to replace the extracted image blocks. The replacement image blocks each have a motion vector of value zero and a difference signal of value zero.

The present invention, by providing replacement picture data which represents replacement image blocks having a motion vector of value zero and a difference signal of value zero, sets the inter-encoded pictures of the modified video sequence to display, when decoded, the same image as that displayed on the previous intra-encoded picture. That is, setting the motion vectors of all image blocks in the inter-encoded picture to zero, and setting the corresponding difference values to zero, specifies that each image block in the inter-encoded picture will refer to an identically positioned image block in another picture (a reference picture) within the group of pictures. Given that the reference picture will either be the intra-encoded picture of the group of pictures, or will eventually (potentially with several intermediate pictures) refer back to the intra-encoded picture of the group of pictures, all inter-encoded pictures within the group of pictures will be viewed, when decoded, as identical to the intra-encoded picture of the group of pictures, that is, the same image will be viewed for the entire duration of the group of pictures. Where the pictures are frames, this will result in an apparent frame rate much lower than the actual frame rate (all pictures will still be decoded by the decoder and displayed, there will simply be a number of repetitions of the same image). This enables a user to gain an appreciation of the content of the video sequence and the quality of the individual pictures, without having access to an unprotected version of the video sequence.

Due to the presence of the original picture data within the bitstream, albeit in compressed form, a user can, recreate the original bitstream from the modified bitstream and thereby access the original content. Preferably, the compressed bitstream will be encrypyted, in which case only an authorised user will be able to access the original content, with the use of a suitable decoder and any necessary cryptographic keys.

The present invention is particularly advantageous when used in conjunction with visible watermarking. When an inter-encoded video sequence is subject to watermarking, the motion vectors present in the inter-encoded pictures tend to distort the watermark embedded into the intra-encoded pictures when the video sequence is decoded, particularly for a video sequence in which there is a great deal of motion, and therefore large magnitude motion vectors. This effect is not visually pleasing. With the present technique, the inter-encoded pictures are, as far as the decoder is concerned, stationary copies of the intra-encoded watermarked picture. Accordingly, there is no distortion of the watermarked image.

Additionally, this combination of techniques makes unauthorised removal of the watermark from the intra-encoded pictures more difficult by inhibiting the use of motion compensation techniques to estimate properties of the image behind the watermark. This is because the inter-encoded pictures will not provide an unauthorised user with any additional information compared with that provided by the related intra-encoded picture.

In the case of MPEG2, although the same principles may also apply to other long GOP encoding schemes, the replacement picture data may simply be a standard code which can be applied to every inter-encoded picture. With MPEG2, two standard codes can be used, one to be applied as replacement picture data for each P-picture, and one to be applied as replacement picture data for each B-picture. For improved performance, the codes used for B-pictures set the motion vectors to refer to a subsequent picture within the group of pictures. The predetermined codes for each of the P-pictures and B-pictures may include code portions which represent a row of macroblocks within the inter-encoded picture, and each of the code portions may define only the first and the last macroblock of the row. This utilises the capability of an MPEG2 decoder to process intermediate “skipped macroblocks” as identical to the preceding macroblock where these intermediate macroblocks are not actually specified in the encoded bitstream.

According to a second aspect of the present invention, there is provided a method of removing modifications made to a modified compression encoded video sequence representing a video image. The compression encoded video sequence includes groups of pictures comprising an intra-encoded picture and at least one inter-encoded picture, the inter-encoded picture comprising a plurality of image blocks. At least one of the image blocks has a motion vector representing a displacement of the image block with respect to a reference image block in another picture in the group of pictures, and a difference signal representing a difference between the image block and the reference image block. The modified video sequence comprising replacement image blocks and compressed image block data formed from original image blocks. The method comprises the steps of detecting, for each group of pictures, the inter-encoded pictures within the video sequence, extracting the compressed image block data from the detected inter-encoded pictures, decompressing the extracted compressed image block data to recreate the original image blocks, and replacing the predetermined replacement image blocks and the compressed image block data with the original image blocks. The predetermined replacement image blocks each have a motion vector of value zero and a difference signal of value zero.

Where the compressed image block data has been encrypted, the extracted compressed image block data is decrypted prior to being decompressed. If the compressed image block data has been encrypted using a secret key, the key will need to be obtained and used to decrypt the encrypted compressed image block data.

A video sequence distribution system may also be provided and may comprise a server apparatus and a client apparatus. The server apparatus is operable to provide to the client apparatus a compression encoded video sequence modified according to the above first aspect of the invention, and to provide the client apparatus with information for reversing the modifications made to the modified compression encoded video sequence. The information for reversing the modifications made to the modified compression encoded video sequence may be a secret key.

The client apparatus of the video sequence distribution system may be operable to request from the server apparatus the information for reversing the modifications made to the modified compression encoded video sequence, and to reverse the modifications made to the modified compression encoded video sequence according to the above second aspect of the invention.

Various aspects and features of the present invention are defined in the appended claims, which include an apparatus for modifying a video sequence, an apparatus for removing modifications made to a video sequence, an information signal and a computer program.

### BRIEF DESCRIPTION OF THE DRAWINGS

Example embodiments of the present invention will now be described with reference to the accompanying drawings, where like parts are provided with corresponding reference numerals and in which:

FIG. 1 is a schematic diagram of an image frame;

FIG. 2 is a schematic diagram of blocks of 8×8 pixels in the image frame;

FIG. 3 is a schematic diagram of a DCT block;

FIG. 4 is a schematic diagram of macroblocks;

FIG. 5 is a schematic diagram of rows of macroblocks and slices;

FIG. 6 is a schematic diagram of a Group of Pictures (GOP);

FIG. 7 is a schematic diagram of one frame of picture data;

FIG. 8 is a schematic diagram of a bitstream of one macroblock;

FIG. 9 is a schematic diagram of a bitstream modifying apparatus according to a first embodiment of the invention;

FIG. 10 is a flow diagram schematically illustrating an overview of a bitstream modifying method according to the first embodiment of the invention;

FIGS. 11A and 11B are schematic diagrams illustrating the effect of the bitstream modifying method of the first embodiment on an example bitstream;

FIGS. 12A and 12B are schematic diagrams illustrating the structure of an I-picture or a B-picture before and after modification;

FIGS. 13A and 13B are schematic diagrams illustrating the macroblock structure before and after modification;

FIGS. 14A to 14D are tables schematically illustrating example MPEG2 codes used to achieve the macroblock structure of FIG. 13B;

FIG. 15 schematically illustrates a bitstream washing apparatus for restoring a bitstream modified by the apparatus and method of FIGS. 9 and 10 to its original form;

FIG. 16 is a flow diagram schematically illustrating an overview of a bitstream washing method;

FIG. 17 is a schematic diagram of a bitstream modifier according to a second embodiment of the invention;

FIGS. 18A and 18B are schematic diagrames illustrating the effect of the bitstream modifying method of the second embodiment on an example bitstream;

FIG. 19 schematically illustrates a bitstream washing apparatus for restoring a bitstream modified by the apparatus of FIG. 17 to its original form.

### DESCRIPTION OF THE EXAMPLE EMBODIMENTS

In the following description, embodiments of the invention will be described with reference to MPEG2 as an encoding method. It will be appreciated that alternative encoding methods could also be used, provided that they operate on the basis of a long GOP structure. Further, the following description refers mainly to pictures rather than specifying frames or fields. The present invention may be used both on a frame or field basis.

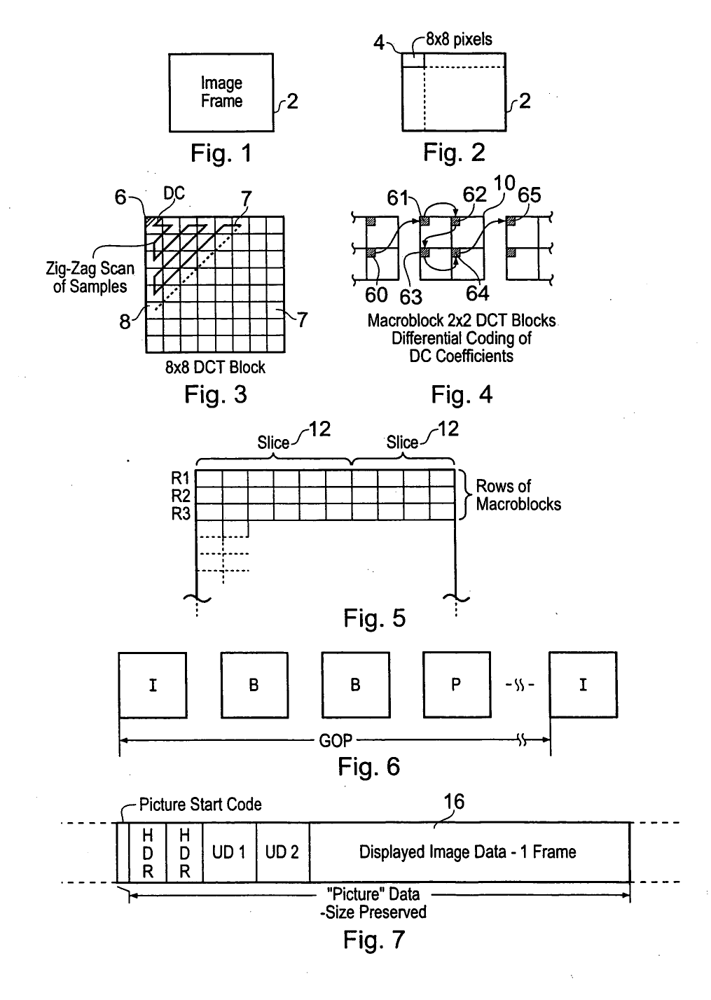

Firstly, MPEG2 will be reviewed. Referring to FIG. 1, an image frame 2 is shown. The image is represented by pixels. As shown in FIG. 2, blocks 4 of 8×8 pixels are selected and as shown in FIG. 3, those blocks are subject to a Discrete Cosine Transform (DCT) to form DCT blocks containing 8×8 DCT coefficients. The coefficients include a DC coefficient 6 and AC coefficients 7. To form a serial bitstream the coefficients are scanned in a zig-zag scan pattern 8 as illustrated in FIG. 3, although other patterns are known. Groups of four adjacent DCT blocks are grouped into macroblocks 10 as shown in FIG. 4. As shown in FIG. 5, the image frame is organised as rows R1, R2, R3 etc. of macroblocks. The macroblocks are organised into slices. A slice is a horizontal collection of macroblocks. A new slice starts at the beginning of each row of macroblocks. A slice may contain any number of macroblocks and a row of macroblocks may contain any number of slices.

Referring to FIG. 6, MPEG2 has the following types of frame. An I frame, which is an intra encoded frame in which all the image data is contained in that frame without reference to any other frame. A P frame is a frame that is coded using motion compensated prediction from a previous I frame or P frame. A B frame is a frame coded using motion compensated prediction from a previous and/or future I frame or P frame.

Frames are organised into Groups of Pictures (GOPs). FIG. 6 shows part of a typical GOP in which a repeated sequence of I, B, B and P frames form the GOP. Other sequences are possible. The number of frames in a typical GOP is 12 or 15, but other numbers of frames are possible.

FIG. 7 illustrates the data format of what is referred to herein as picture data. Picture data herein includes all data between picture start codes and includes headers (HDR), userdata (UD) and the image data 16 representing one frame of the image. MPEG2 allows user data (UD) to be placed in the picture data ahead of the image data 16. There may be no user data fields UD or one or more user data fields.

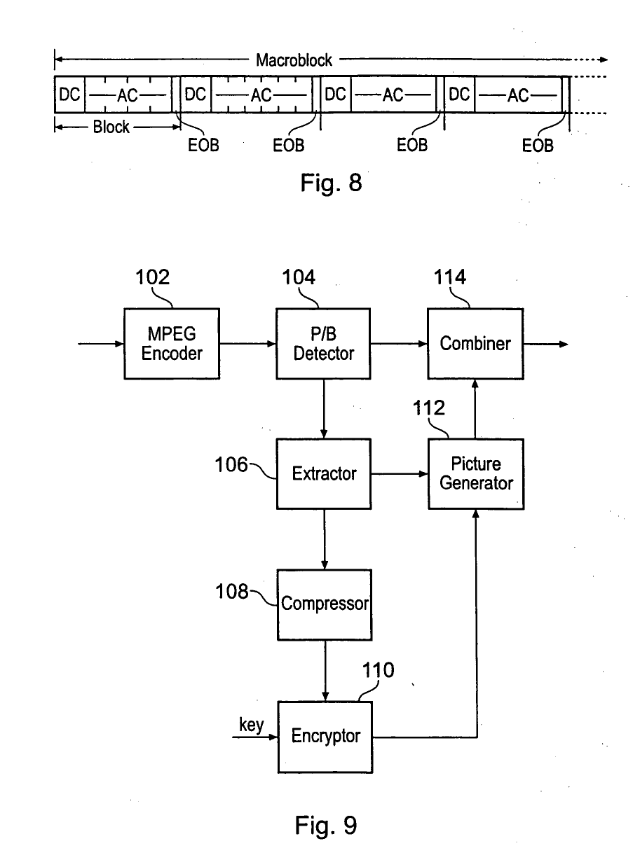

The DCT blocks and macroblocks are formatted as shown in FIG. 8 within the image data 16. A macroblock may consist of 6, 8 or 10 DCT blocks, depending on the chroma format, [4,2,0], [4,2,2] or [4,4,4], used, although only the first four DCT blocks are shown in FIG. 8. Each block includes a DC coefficient followed by AC coefficients. Blocks are separated by End of Block codes EOB.

An MPEG2 encoding process should produce a bitstream which can be decoded by any decoder which complies with the MPEG2 standard. Decoders include a buffer which temporarily stores the bitstream as it is decoded in the buffer. The MPEG2 standard defines the size of the buffer. Generally, the buffer should neither underflow nor overflow otherwise data will be lost, although underflow may be allowed under certain conditions. The encoding process is therefore carried out such that the bit rate is constrained to prevent underflow and overflow.

Bitstream Modifying Apparatus

FIG. 9 schematically illustrates a bitstream modification apparatus in accordance with a first embodiment of the invention. The bitstream modification apparatus in the present example comprises an MPEG encoder 102 arranged to receive a video signal at its input and to output an MPEG2 encoded video bitstream. Alternatively, the bitstream modification apparatus could simply receive a pre-prepared MPEG2 bitstream. The MPEG2 bitstream is passed to a P/B picture detector 104, which determines whether a current picture in the bitstream is an intra-encoded picture (an I-picture) or an inter-encoded picture (a P-picture or a B-picture). In the case that the detected current picture is an I-picture, no modification will be made. In the case that the detected current picture is a P-picture or a B-picture, the portion of the bitstream relating to the current picture will be modified.

Specifically, where the current picture is an inter-encoded picture, the portion of the bitstream representing the current picture will be extracted by an extractor 106. The extractor will communicate at least a portion of the extracted bitstream to a compression encoder 108, which will reduce the data volume of that portion of the bitstream. Any suitable compression algorithm could be used. It will be appreciated however that the bitstream is already compressed, since it is an MPEG2 bitstream. The further compression performed by the compression encoder 108 could for instance use a modified MPEG2 compression algorithm, or alternatively could be MPEG4 compression.

The compressed bitstream is then passed to an encryption encoder 108, where it will be encrypted to prevent unauthorised access to the current picture in its original form. As with compression, any suitable encryption algorithm could be used. However, it is preferred that a symmetric encryption algorithm, such as the AESI algorithm, is used to encrypt the data with a secret key. Symmetric algorithms have the advantage over asymmetric algorithms that the encryption results in a smaller expansion of data volume and that they are faster to perform. However, if additional security is required, the secret key could itself be subject to encryption before dissemination, for instance by encrypting it in accordance with a public key infrastructure (PKI).

The bitstream modification apparatus is provided with a inter-encoded picture generator 112 for generating replacement P-pictures and B-pictures for replacing the original P-pictures and B-pictures. The replacement P-pictures and B-pictures. are encoded in such a way as to represent an image identical to that specified by the previous I-picture, that is, by the first picture in the GOP. In this way, all pictures in the GOP will appear identical. Where, for instance, a series of GOPs are provided each comprising say 12 pictures, each picture being a frame, if the viewed frame rate is 12 frames per second, the apparent frame rate will be approximately 2 frames per second. The replacement P-pictures and B-pictures are then passed to a picture combiner 114 which combines the original, unmodified I-pictures with the replacement P-pictures and B-pictures to generate an output modified MPEG2 video sequence.

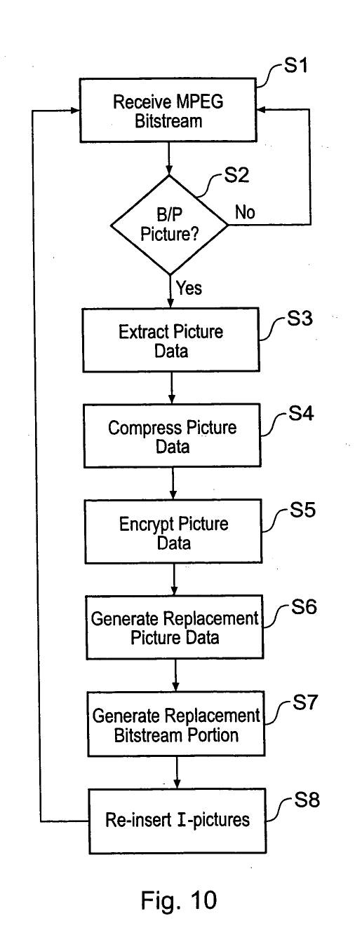

FIG. 10 is a flow diagram which schematically illustrates the steps carried out in modifying an MPEG2 bitstream. First, at a step S1, a picture of an MPEG2 bitstream is received. At a step S2, it is determined whether the received picture is an intra-encoded picture (I-picture) or an inter-encoded picture (P-picture or B-picture). If the received picture is an I-picture, processing returns to the step S1, where a subsequent picture will be received. Alternatively, if the received picture is determined to be a P-picture or a B-picture, then at a step S3, picture data will be extracted from the current picture. Then, at a step S4, the extracted picture data will be compressed to form compressed picture data, and subsequently encrypted to form encrypted compressed picture data.

Replacement picture data is generated, following on from the step S2, at a step S6. As described above with reference to FIG. 9, the replacement pictures are generated such that the image represented by the new picture data of the current picture matches the image represented by the I-picture at the start of the GOP. Then, at a step S7, the encrypted compressed picture data and the replacement picture data are combined to generate a replacement bitstream portion to replace the corresponding received bitstream portion. Finally, at a step S8, the I-pictures of the MPEG bitstream are re-inserted into the replacement bitstream portion to form a modified bitstream.

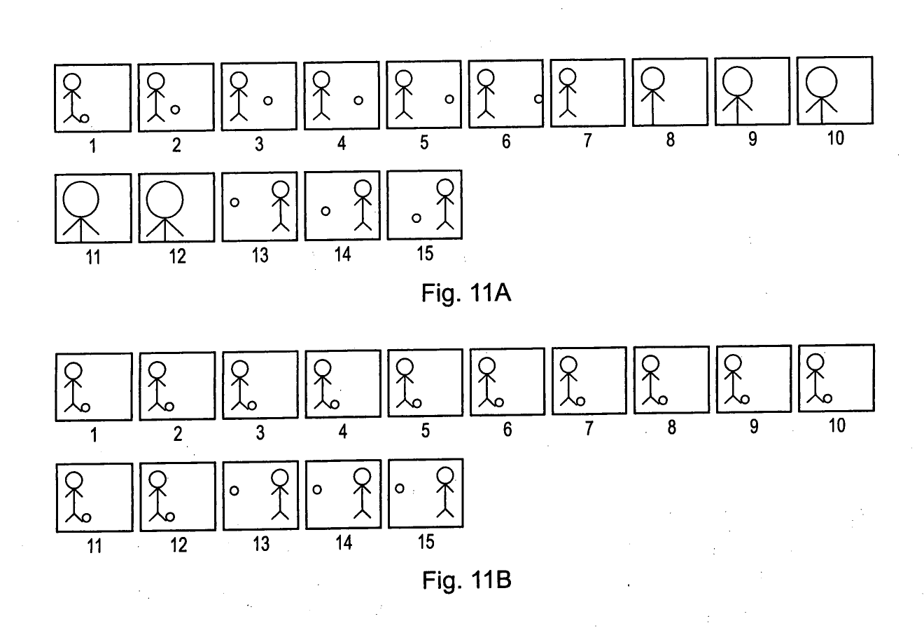

FIGS. 11A and 11B schematically illustrate the effect of modifying a video sequence as described above. Specifically, FIG. 11A illustrates a video sequence prior to modification and FIG. 11B illustrates the same video sequence after modification in accordance with the above method. Referring to FIG. 11A, a series of 15 sequential pictures are shown, numbered as pictures 1 to 15. Comparison of these pictures shows that there is motion occurring between pictures. When viewed in real time, for instance at a frame rate of 25 pictures per second, this inter-picture motion will appear smooth. Referring to FIG. 11B, after modification, pictures 1 and 13 are identical to pictures 1 and 13 of FIG. 11A, however, pictures 2 to 12, 14 and 15 differ from the corresponding pictures of FIG. 11A. Pictures 1 and 13 are identical because these pictures are I-pictures, the present example comprising a GOP having a length of 12 pictures (an I-picture followed by 11 P-pictures and/or B-pictures), and are therefore unchanged by the modification method. However, pictures 2 to 12 of FIG. 11B are identical to picture 1 of FIG. 11B, and pictures 14 and 15 are identical to picture 13 of FIG. 11B, because these pictures have been modified to appear identical to the I-picture of the GOP. Accordingly, when viewed in real time, the sequence of FIG. 11B appears jumpy, having an apparent frame rate of only 2 frames per second. This apparent frame rate, although sufficient to provide an indication of the information content of the video sequence, and also having the fall image quality for each individual picture, does not represent fully usable video. Accordingly, a third party requires access to the secret key used to encrypt the original P-picture and B-picture data in order to decrypt the original data and restore the full video sequence where the encryption is symmetric.

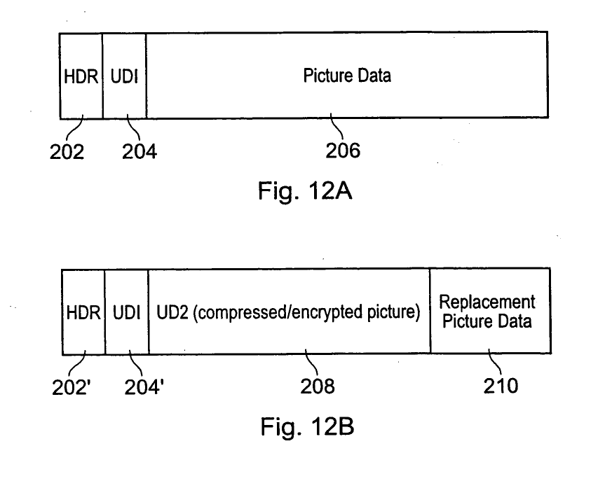

FIGS. 12A and 12B schematically illustrate an example MPEG2 picture structure prior to modification (FIG. 12A) and after modification (FIG. 12B). In both FIGS. 12A and 12B, a picture header 202 and 202′ respectively, are provided. The picture headers 202 and 202′ are followed by a first user data block 204 and 204′ respectively. It will be appreciated that any number of user data blocks may be present in the bitstream. In FIG. 12A, the user data block 204 is followed by the picture data 206 which represents the image values of the current picture. It is this block of picture data 206 which is extracted, compressed and encrypted, and is then inserted back into the bitstream as a user data block 208. Following the new user data block 208 is replacement picture data 210 used to define the current picture to appear identical to a preceding I-picture. An MPEG2 decoder, when decoding the picture, will ignore the presence of this user block and decode only the replacement picture data 210 to provide the image.

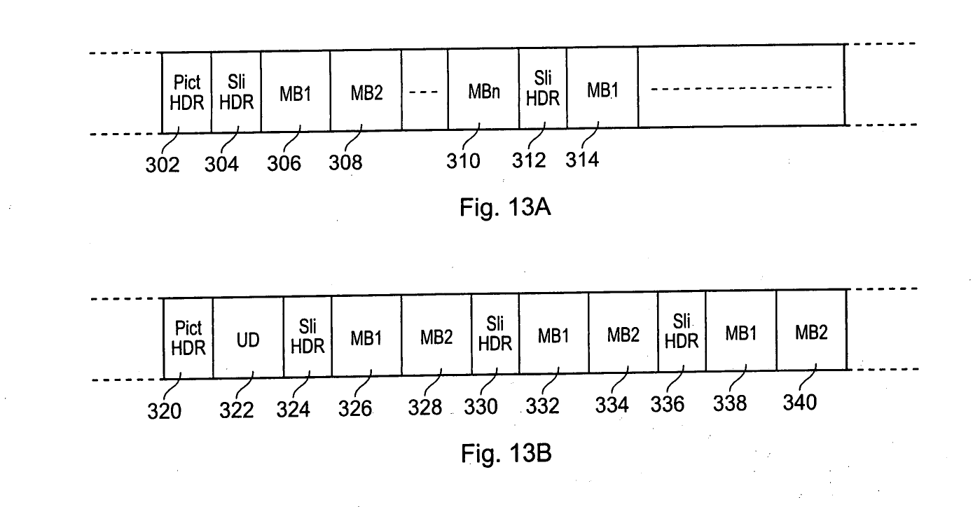

FIGS. 13A and 13B illustrate an example MPEG2 slice and macroblock structure prior to modification (FIG. 13A) and after modification (FIG. 13B). In the present example, no user data is present in the original bitstream portion represented by FIG. 13A. Referring to FIG. 13A, a picture header 302 is provided which indicates the start of a new picture in the MPEG2 bitstream. This picture header 302 is followed by a slice header 304 which indicates the start of a new slice within a current picture. Any slices following the picture header 302 and which occur before another picture header belong to the same current picture. The slice header 304 is followed by one or more macroblocks. In the present case, N macroblocks are provided, including macroblocks 306, 308 and 310. After the final macroblock 310 in the slice, a new slice header 312 is provided to indicate the start of a new slice. As with slice header 304, slice header 312 is followed by one or more macroblocks, in this case including a macroblock 314. Each slice may include a large number of macroblocks, depending on the length of the slice. For instance, in the case of a standard definition (SD) picture, a slice could comprise up to 45 macroblocks (if the slice takes up an entire row of the picture), and in the case of a high definition (HD) picture, a slice could comprise up to 120 macroblocks.

Referring now to FIG. 13B, a picture header 320 is provided which corresponds to the picture header 302 of FIG. 13A. Following the picture header 320 is a user data block 322 which holds the encrypted compressed original picture data from the picture of FIG. 13A. The encypted compressed original picture data contains the original slices and macroblocks present in the bitstream of FIG. 13A. The user data block 322 is followed by a slice header 324, which may correspond to the slice header 304 of FIG. 13A. Following the slice header 324 are a first macroblock 326 and a second macroblock 328. That is, only two macroblocks are defined in the first slice, although the slice may actually represent a full row of macroblocks. The first slice may or may not correspond in terms of the portion of a row it represents to the first slice of FIG. 13A. In one implementation, the same slice structure is provided, such that the same number of slices represent the picture represented by FIG. 13A and the picture represented by FIG. 13B. However, preferably, a new slice structure is defined in which each slice corresponds to an entire row of macroblocks within the picture, resulting in the minimum number of slices being used to represent the modified picture. This provides improved coding efficiency in that a smaller number of bits are required to define the replacement picture data.

The two macroblocks in the first slice of FIG. 13B are the first and last macroblocks of the slice. MPEG2 defines that not all macroblocks need to be transmitted under certain circumstances. Macroblocks which are not transmitted are referred to as “skipped macroblocks”. In P-picture, skipped macroblocks are defined as having zero DCT coefficients and zero motion vectors. In B-pictures, skipped macroblocks are defined as having zero DCT coefficients and motion vectors the same as the previous macroblock. As a result of these definitions, if, as is the case in the present example, only the first and last macroblocks of the slice are transmitted, all skipped macroblocks defined in between will be identical to the first macroblock. Accordingly, if the first and last macroblocks are set with zero DCT coefficients and zero motion vectors, regardless of whether the picture is a P-picture or a B-picture, the entire slice will have zero DCT coefficents and zero motion vectors, which will result in the slice being interpreted at a decoder as appearing identical to the corresponding portion of another picture in the GOP.

The same principle is used throughout every row of the picture, as can be seen in FIG. 13B, where a second slice header 330 is provided followed by two macroblocks 332 and 334, and a third slice header 336 is followed by two macroblocks 338 and 340. In this way, the whole B-picture or P-picture can be encoded in such a way as to be decoded to be identical to another picture in the GOP, and ultimately identical to the previous I-picture.

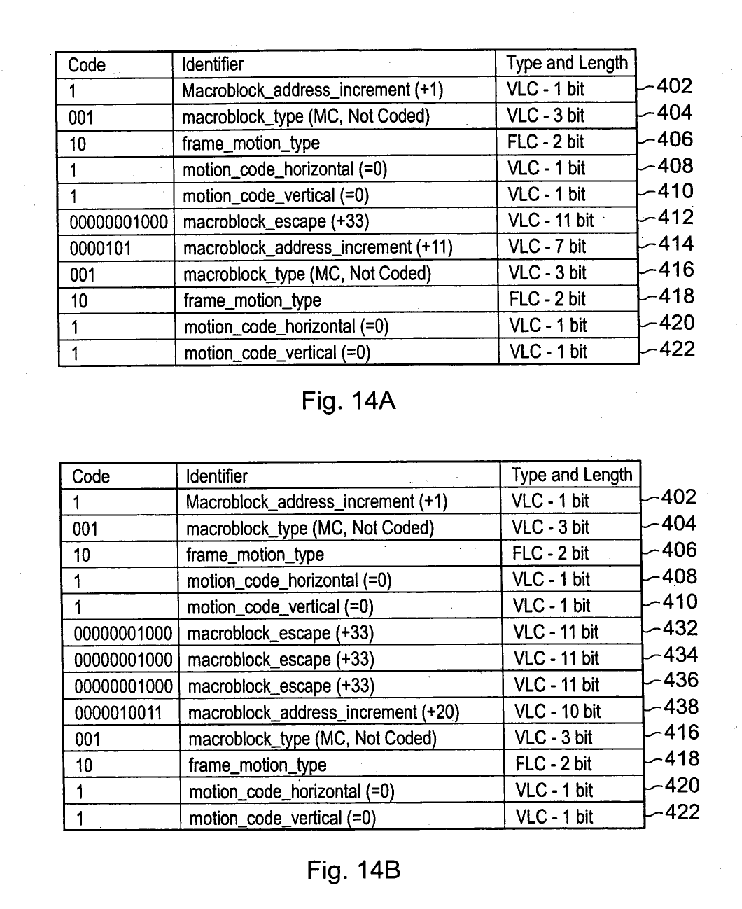

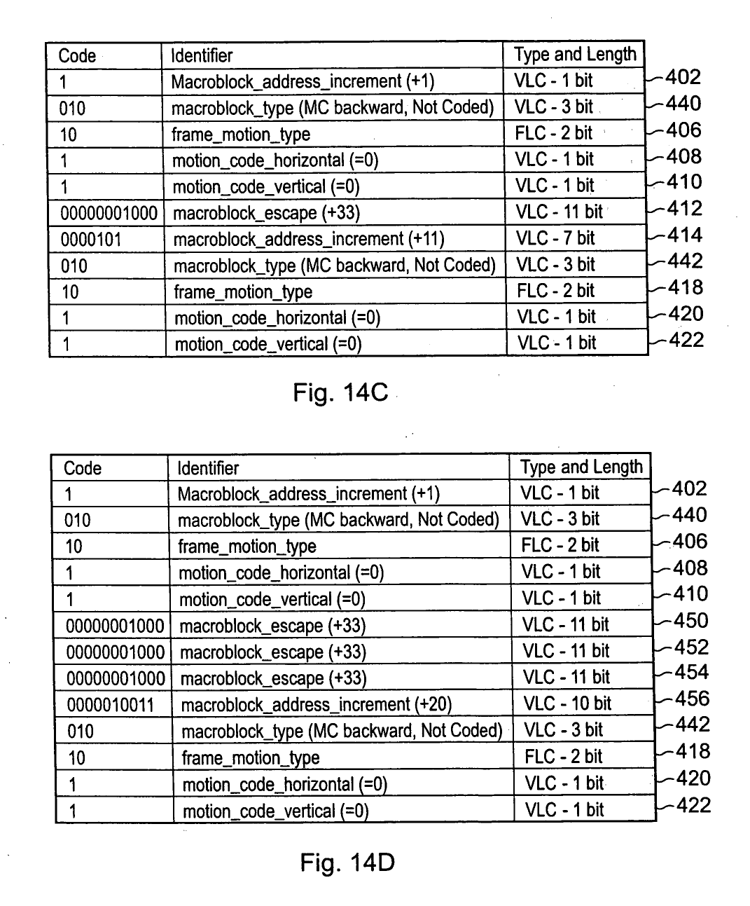

FIGS. 14A to 14D schematically illustrate MPEG2 codes which can be used to achieve an appropriate macroblock structure as described above with reference to FIG. 13B. No change to the first slice header of a row is required to achieve the above described macroblock structure, and so slice header codes are not defined in FIGS. 14A to 14D. FIGS. 14A to 14D set out the example MPEG2 codes used in the first column of the table, the code identifier in the second column, and whether the code is a variable length code (VLC) or a fixed length code (FLC), as well as the code length in the present case, in the third column. FIG. 14A is a table setting out the MPEG2 codes required for coding the first and last macroblocks of a slice (and through the use of skipped macroblocks all intermediate macroblocks) in the case of a standard definition (SD) P-picture. A standard definition picture may comprise 720 samples per line, and 576 lines per image for both PAL and NTSC formats. The MPEG2 codes shown in FIG. 14A would commence after the slice header.

The first code provided is a macroblock_address_increment code 402. This increments a current address to specify a particular macroblock position within the current slice. In this case the amount by which the macroblock address is incremented is +1. The initial value for the macroblock address is zero, so the macroblock_address_increment code 402 increments the macroblock address to 1, in order to code the first macroblock. The next code is a macroblock_type code 404, which specifies the type of macroblock which is encoded. In this case the macroblock_type is specified as a forward motion compensated (MC) macroblock in which no DCT values are coded. Following this is a frame_motion_type code 406 which sets the prediction type for frame pictures, in this case to frame prediction. The following two codes are motion_code horizontal 408 and motion_code vertical 410, which set the horizontal and vertical motion vectors for the macroblock, in this case to zero. The above codes 402-410 represent the first macroblock in the slice. The remaining codes in the table represent the last macroblock in the slice.

The first code of the last macroblock is a macroblock_escape code 412 which serves in this case to increment the macroblock address by +33. The reason for the use of the macroblock_escape code in this instance is that this code is used in combination with the macroblock_address_increment code where the address difference between two macroblock addresses exceeds 33. In the present case, the desired macroblock address is 45, which is the macroblock address for the last macroblock in a row for a standard definition picture. Accordingly, from the macroblock address of 1 for the first macroblock, an increment of +44 is required. Therefore, the macroblock_escape code is used to provide a +33 increment, and as can be seen from the table, the remaining +11 is provided by a macroblock_address_increment code 414.

The macroblock_type code 416, the frame_motion_type code 418, the motion_code horizontal 420 and the motion code vertical 422 are all identical to the corresponding codes 404 to 410 used for the first macroblock, resulting in identical first and last macroblocks of the row which are predictively encoded with zero motion vectors and zero difference values. As described above, an MPEG2 decoder will fill in between these first and last macroblocks with skipped macroblocks which will be identical to these first and last macroblocks in the slice.

FIG. 14B corresponds to FIG. 14A but relates to a high definition case where a row, and thus a slice, comprises 120 macroblocks. A high definition picture may comprise 1920 samples per line and 1080 lines per image, or may alternatively comprise 1280 samples per line and 720 lines per image for both PAL and NTSC formats. Identical codes are marked with identical reference numerals in FIGS. 14A and 14B, perform an identical function, and will not be described again with reference to FIG. 14B. However, in the case of FIG. 14B, three macroblock_escape codes 432, 434 and 436, as well as a macroblock_address_increment code 438 are used in order to provide the required increment of +119 from 1 to 120. In all other ways the MPEG2 coding used in FIG. 14B corresponds to that of FIG. 14A.

FIG. 14C is a table setting out the MPEG2 codes required for coding the first and last macroblocks of a in the case of a standard definition (SD) B-picture in which 45 macroblocks are provided per row. Identical codes are marked with identical reference numerals in FIGS. 14A and 14C, perform an identical function, and will not be described again with reference to FIG. 14B. However, in the case of FIG. 14C, the code macroblock_type is different and sets the macroblock is be a backward motion compensated (MC) macroblock in which no DCT values are coded. This differs from 14A because, while forwards prediction is allowable for a B-picture, it is more optimal under the MPEG2 standard to provide backwards prediction for macroblocks within a B-picture.

FIG. 14D corresponds to FIG. 14C but relates to a high definition case where a row, and thus a slice, comprises 120 macroblocks. Identical codes are marked with identical reference numerals in FIGS. 14C and 14D, perform an identical function, and will not be described again with reference to FIG. 14D. However, in the case of FIG. 14B, three macroblock_escape codes 450, 452 and 454, as well as a macroblock_address_increment code 456 are used in order to provide the required increment of +119 from 1 to 120. In all other ways the MPEG2 coding used in FIG. 14D corresponds to that of FIG. 14D.

It can be seen from column 3 of each of FIGS. 14A to 14D that the number of bits used to represent each pair of macroblocks is 33 bits for the standard definition cases of FIGS. 14A and 14C, and 58 bits for the high definition cases of FIGS. 14B and 14D. In terms of additional data generated by the methods described, the first macroblock in a slice must always be present, so the first macroblock_address_increment is always +1 and can therefore be excluded from a calculation of data expansion. Accordingly, this lowers the number of additional bits to 32 and 57 per slice respectively for the standard definition and high definition cases. This translates to 1152 additional bits per picture for the standard definition cases and 3876 additional bits per picture for the high definition cases. Further, the slice start code present in the slice header is always byte-aligned, and so the data to describe a slice will be padded to a whole number of bytes. Accordingly, the actual amount of data expansion could be slightly larger than these indications. However, the padding bits could potentially be used to store data.

Bitstream Washing Apparatus

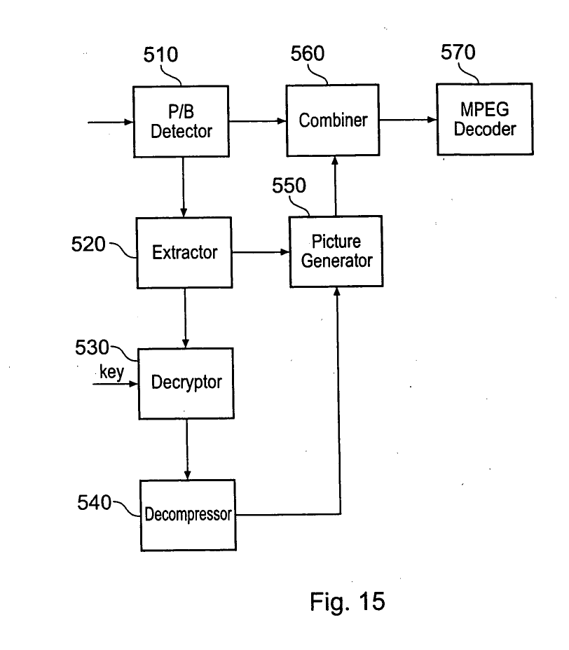

A bitstream washing apparatus for reconstituting the original bitstream from a bitstream modified by the apparatus described in FIG. 9 is schematically illustrated in FIG. 15. The washing apparatus comprises a P/B picture detector 510, which receives a modified MPEG bitstream and determines whether a current picture in the bitstream is an intra-encoded picture (an I-picture) or an inter-encoded picture (a P-picture or a B-picture). In the case that the detected current picture is an I-picture, no processing is required because no modification will have been made to that picture. In the case that the detected current picture is a P-picture or a B-picture, the portion of the bitstream relating to the current picture will be processed to return it to its original form.

Where the current picture is an inter-encoded picture, the portion of the bitstream representing the original picture will be extracted by an extractor 520. The extractor 520 will communicate this portion of the extracted bitstream to a decryptor 530, where it will be decrypted, in accordance with the encryption algorithm used by the encryption encoder used to encrypt the data, to recover the original compressed data. Usually, this will require receiving a key which is required to perform the decryption. The key could however be pre-coded into both the encryption encoder and the decryptor, in which case no transmission of a key would be required. As described with reference to FIG. 9, where a secret key is to be used, it could be further protected using asymmetric PKI encryption before transmission to the recipient.

Once decrypted, the original compressed picture data will be passed to a decompressor 540, which will decompress the compressed picture data to reconstitute the original picture data. The bitstream washing apparatus is provided with a inter-encoded picture generator 550 for recreating the original P-pictures and B-pictures from the unmodified data left in the bitstream and the reconstituted picture data provided from the decompressor. The replacement picture data present in the received bitstream will be removed and discarded. The recreated original P-pictures and B-pictures are then passed to a picture combiner 560 which combines the original, unmodified I-pictures with the recreated original P-pictures and B-pictures to generate a washed MPEG2 video sequence. In the present case, an MPEG2 decoder is also provided to decode the MPEG2 video to generate a viewable video sequence. However, the washed MPEG2 video could simply be stored for later use.

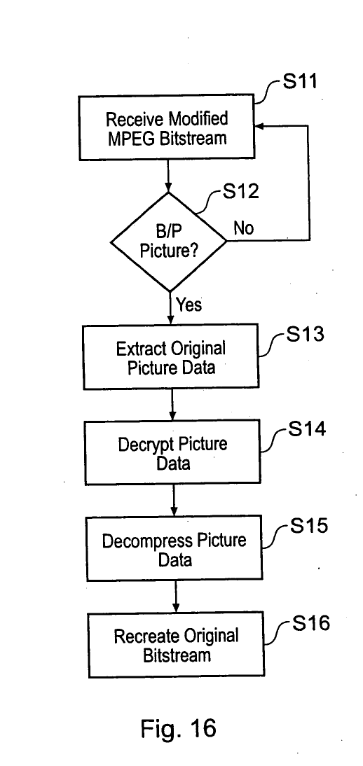

FIG. 16 is a flow diagram which schematically illustrates the steps carried out in washing the MPEG2 bitstream received by the apparatus of FIG. 15. First, at a step S11, a picture of a modified MPEG2 bitstream is received. At a step S12, it is determined whether the received picture is an intra-encoded picture (I-picture) or an inter-encoded picture (P-picture or B-picture). If the received picture is an I-picture, processing returns to the step S11, where a subsequent picture will be received. Alternatively, if the received picture is determined to be a P-picture or a B-picture, then at a step S13, picture data will be extracted from the current picture. Then, at a step S14, the extracted picture data will be decrypted to form compressed picture data, and subsequently decompressed at a step S15 to reconstitute the original picture data. Then, at a step S16, the unmodified parts of the bitstream and the recreated picture data are combined to generate a recreated original bitstream portion to replace the corresponding received bitstream portion, and combined with the unmodified I-pictures in the bitstream to form a recreated original bitstream.

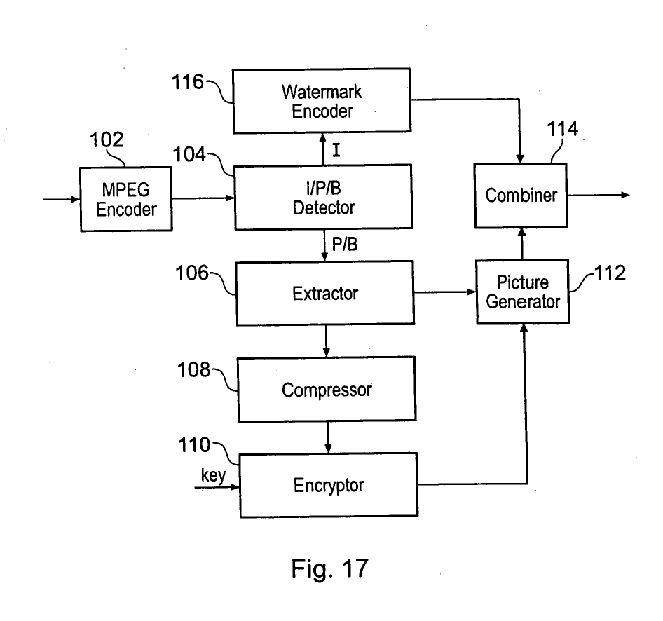

FIG. 17 schematically illustrates a bitstream modification apparatus in accordance with a second embodiment of the invention. The features of FIG. 16 which are identical to the features of FIG. 9 are marked with like reference numerals and will not be described again in detail. As with FIG. 9, the bitstream modification apparatus in the present example comprises an MPEG encoder 102 arranged to receive a video signal at its input and to output an MPEG2 encoded video bitstream, but the bitstream modification apparatus could simply receive a previously generated MPEG2 bitstream. The MPEG2 bitstream is passed to a P/B picture detector 104, which determines whether a current picture in the bitstream is an intra-encoded picture (an I-picture) or an inter-encoded picture (a P-picture or a B-picture). In the case that the detected current picture is a P-picture or a B-picture, the portion of the bitstream relating to the current picture will be modified in the same way as described above in relation to FIG. 9. However, in the case that the detected current picture is an I-picture, a visible watermark will be inserted into the I-picture by a watermark encoder 116. Visible watermarking methods are known in the art, and in the context of MPEG2 usually involve modifying DCT coefficients of I-pictures within a bitstream. Modification of the P and B pictures is also possible, but in the present example is not useful because the modified P and B pictures are purely referential with respect to an I-picture, and any watermark applied to the I-picture will also be represented by the modified P and B pictures by reference. The visible watermarking process may itself encrypt the data removed from the original I-pictures. The encrypted data may be stored in the bitstream relating to the watermarked I-picture in a user data block in the same way as described above for the insertion of original data of the P-pictures and B-pictures into user data blocks. Where a key is used to encrypt data removed from I-pictures through the watermarking process, the same key could be used for both the watermarking encoder and the encryption encoder 110.

The extractor 106, compression encoder 108, encryption encoder 110 and inter-encoded picture generator 112 of FIG. 17 operate in the same way as for FIG. 9 and will not be detailed further here. As with the FIG. 9 embodiment, the replacement P-pictures and B-pictures are encoded in such a way as to represent an image identical to that specified by the previous I-picture, that is, by the first picture in the GOP. In this way, all pictures in the GOP will appear identical.

The picture combiner 114, as with FIG. 9, combines the I-pictures and the replacement P-pictures and B-pictures, but in this case, the I-pictures have been watermarked by the watermark encoder 116. Accordingly, at a decoder, a user will view the image as a 2 picture per second video sequence in which a watermark, such as a logo, is visible in all pictures.

Accordingly, it will be appreciated that the method of modifying a bitstream used in accordance with FIG. 17 is identical to that of FIG. 9 except for an additional step of watermarking detected I-pictures and a modified step of combining the watermarked I-pictures with the modified P-pictures and B-pictures.

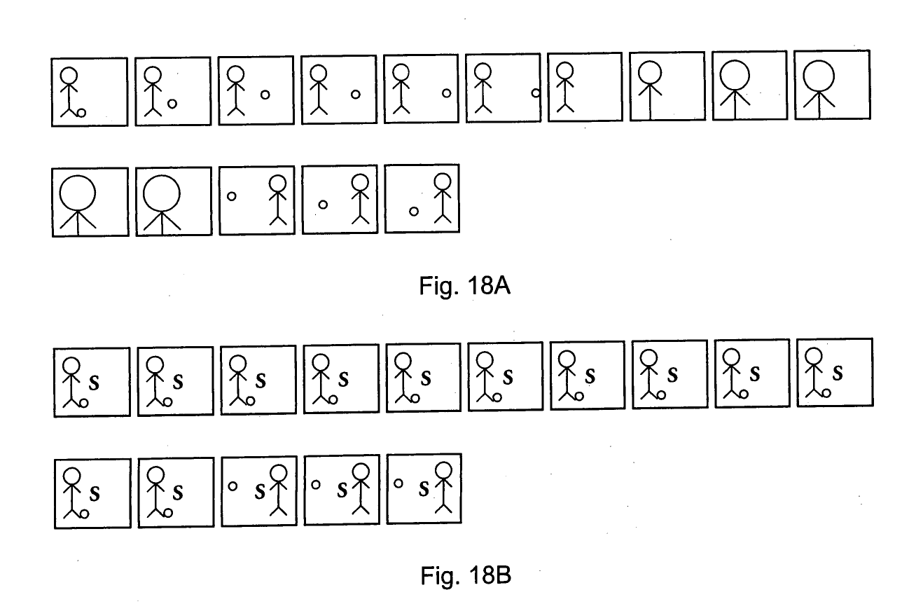

FIGS. 18A and 18B schematically illustrate the effect of modifying a video sequence as described above in relation to FIG. 17. Specifically, FIG. 18A illustrates a video sequence prior to modification and FIG. 18B illustrates the same video sequence after modification. Referring to FIG. 18A, a series of 15 sequential pictures are shown, numbered as pictures 1 to 15. Comparison of these pictures shows that there is motion occurring between pictures. When viewed in real time, for instance at a frame rate of 25 frames per second, this inter-picture motion will appear smooth. Referring to FIG. 18B, after modification, pictures 1 and 13 are identical to pictures 1 and 13 of FIG. 18A except for the addition of a watermark “S”, however, pictures 2 to 12, 14 and 15 differ from the corresponding pictures of FIG. 18A not only in terms of the addition of a watermark, but also in terms of content. Pictures 1 and 13 are identical (other than the watermark) because these pictures are I-pictures, the present example comprising a GOP having a length of 12 pictures (an I-picture followed by 11 P-pictures and/or B-pictures), and are therefore unchanged by the modification of P-pictures and B-pictures. However, pictures 2 to 12 of FIG. 18B are identical to picture 1 of FIG. 18B, and pictures 14 and 15 are identical to picture 13 of FIG. 18B, because these pictures have been modified to appear identical to the I-picture of the GOP, which itself has been modified to include the watermark. Accordingly, when viewed in real time, the sequence of FIG. 18B appears jumpy, having an apparent frame rate of only 2 frames per second, but with a static watermark.

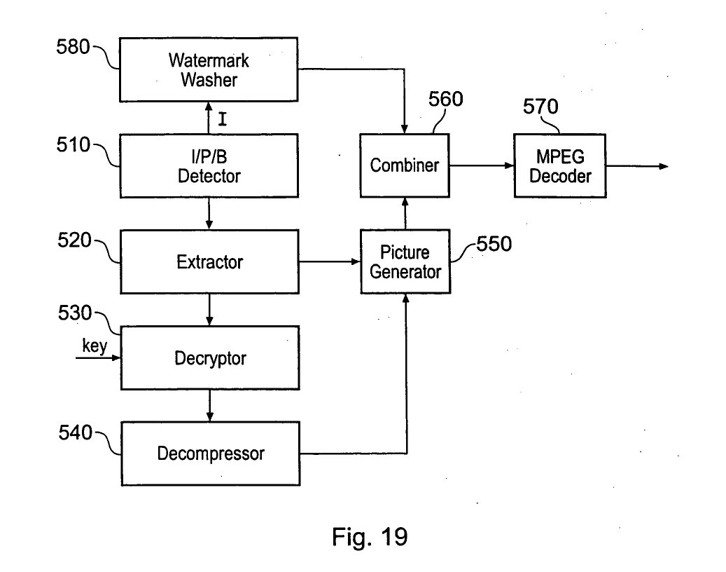

A bitstream washing apparatus for reconstituting the original bitstream from a bitstream modified by the apparatus described in FIG. 17 is schematically illustrated in FIG. 19. The features of FIG. 19 which are identical to the features of FIG. 15 are marked with like reference numerals and will not be described again in detail. The washing apparatus comprises a P/B picture detector 510, which receives a modified MPEG bitstream and determines whether a current picture in the bitstream is an intra- encoded picture (an I-picture) or an inter-encoded picture (a P-picture or a B-picture). In the case that the detected current picture is a P-picture or a B-picture, the portion of the bitstream relating to the current picture will be processed to return it to its original form in accordance with the method described with reference to FIG. 15.

Where an I-picture is detected, that picture will be passed to a watermark washer 580, which will, using the same secret key used in the watermarking process, remove the watermark from the I-picture and reinstate the original data.

Specifically, the extractor 520, the decryptor 530, decompressor 540 and the inter-encoded picture generator 550 each operate in the same way as in FIG. 15. The recreated original P-pictures and B-pictures are then passed to a picture combiner 560 which combines the washed I-pictures with the recreated original P-pictures and B-pictures to generate a washed MPEG2 video sequence. In the present case, an MPEG2 decoder is also provided to decode the MPEG2 video to generate a viewable video sequence. However, the washed MPEG2 video could simply be stored for later use. As with the bitstream modifier, the bitstream washer could use the same secret key for both the decryptor 530 and the watermark washer 580.

The second embodiment has been described as an apparatus in which a visible watermark is applied to the I-pictures of a bitstream and modification has taken place on the P-pictures and B-pictures of a bitstream at substantially the same time in the same apparatus. This option is advantageous because the two operations are related, share common features, for instance the detection of I, P and B pictures and the combination of I, P and B pictures, and it is desirable that they be performed together. However, alternatively, the apparatus and method of the first embodiment could be applied to a previously watermarked MPEG2 bitstream and provide substantially the same effect as the second embodiment. Further, a separate watermarking apparatus could apply a watermark to a bitstream generated by the bitstream modifier of the first embodiment, to again provide substantially the same effect as the second embodiment.

The bitstream modifier and the bitstream washer may be provided as dedicated apparatuses or as computers running suitable software.

1. A method of modifying a compression encoded video sequence representing a video image, the compression encoded video sequence including groups of pictures comprising an intra-encoded picture and at least one inter-encoded picture, the inter-encoded picture comprising a plurality of image blocks, at least one of the image blocks having a motion vector representing a displacement of the image block with respect to a reference image block in another picture in the group of pictures, and a difference signal representing a difference between the image block and the reference image block, the method comprising the steps of:
detecting, for each group of pictures, the inter-encoded pictures within the group of pictures;
extracting the image blocks from the detected inter-encoded pictures;
compressing at least a portion of the extracted image blocks to form compressed image block data; and
inserting replacement image blocks and the compressed image block data into the video sequence to replace the extracted image blocks, wherein
the replacement image blocks each have a motion vector of value zero and a difference signal of value zero.

2. A method of modifying a compression encoded video sequence according to claim 1, comprising the step of encrypting the compressed image block data.

3. A method of modifying a compression encoded video sequence according to claim 1, comprising the step of embedding a visible watermark into one or more intra-encoded pictures of the video sequence.

4. A method of modifying a compression encoded video sequence according to claim 1, wherein each inter-encoded picture is one of a predictively encoded picture in which an image block has a single motion vector, or a bidirectionally encoded picture in which an image block has a plurality of motion vectors, each representing a displacement of the image block with respect to a respective reference image block in another picture in the video sequence.

5. A method of modifying a compression encoded video sequence according to claim 4, wherein the detecting step comprises detecting whether the inter-encoded picture is a predictively encoded picture or a bidirectionally encoded picture, and wherein the replacement image blocks comprise a first predetermined code for replacing a detected predictively encoded picture or a second predetermined code for replacing a bidirectionally encoded picture.

6. A method of modifying a compression encoded video sequence according to claim 5, wherein the video sequence is an MPEG2 bitstream and the image blocks are MPEG2 macroblocks, said first and second predetermined codes each comprising code portions each representing a row of macroblocks within the inter-encoded picture, each of said code portions defining only the first and the last macroblock of the row.

7. A method of assembling a compression encoded video sequence representing a video image, comprising the steps of
generating a compression encoded video sequence; and
modifying the generated compression encoded video sequence in accordance with the method of any one of claims 1 to 6.

8. An apparatus for modifying a compression encoded video sequence representing a video image, the compression encoded video sequence including groups of pictures comprising an intra-encoded picture and at least one inter-encoded picture, the inter-encoded picture comprising a plurality of image blocks, at least one of the image blocks having a motion vector representing a displacement of the image block with respect to a reference image block in another picture in the group of pictures, and a difference signal representing a difference between the image block and the reference image block, the apparatus comprising:
a picture detector, operable to detect for each group of pictures the inter-encoded pictures within the video sequence;
an extractor, operable to extract the image blocks from the detected inter-encoded pictures;
a compression encoder, operable to compress at least a portion of the extracted image blocks to form compressed image block data; and
a picture generator, operable to insert replacement image blocks and the compressed image block data into the video sequence to replace the extracted image blocks, wherein
the replacement image blocks each have a motion vector of value zero and a difference signal of value zero.

9. An apparatus for modifying a compression encoded video sequence according to claim 8, comprising an encryption encoder for encrypting the compressed image block data.

10. An apparatus for modifying a compression encoded video sequence according to claim 8, comprising a watermark encoder for embedding a visible watermark into one or more intra-encoded pictures of the video sequence.

11. A method of reversing modifications made to a modified compression encoded video sequence representing a video image, the compression encoded video sequence including groups of pictures comprising an intra-encoded picture and at least one inter-encoded picture, the inter-encoded picture comprising a plurality of image blocks, at least one of the image blocks having a motion vector representing a displacement of the image block with respect to a reference image block in another picture in the group of pictures, and a difference signal representing a difference between the image block and the reference image block, the modified video sequence having therein replacement image blocks and compressed image block data formed from original image blocks, the method comprising the steps of:
detecting, for each group of pictures, the inter-encoded pictures within the video sequence;
extracting the compressed image block data from the detected inter-encoded pictures;
decompressing the extracted compressed image block data to recreate the original image blocks; and
replacing the replacement image blocks and the compressed image block data with the original image blocks, wherein
replacement image blocks each have a motion vector of value zero and a difference signal of value zero.

12. A method of reversing modifications made to a compression encoded video sequence according to claim 11, comprising the step of decrypting the compressed image block data.

13. A method of reversing modifications made to a compression encoded video sequence according to claim 11, comprising the step of removing a visible watermark from one or more intra-encoded pictures of the video sequence to restore the original intra-encoded pictures.

14. An apparatus for reversing modifications made to a modified compression encoded video sequence representing a video image, the compression encoded video sequence including groups of pictures comprising an intra-encoded picture and at least one inter-encoded picture, the inter-encoded picture comprising a plurality of image blocks, at least one of the image blocks having a motion vector representing a displacement of the image block with respect to a reference image block in another picture in the group of pictures, and a difference signal representing a difference between the image block and the reference image block, the modified video sequence having therein replacement image blocks and compressed image block data formed from original image blocks, the apparatus comprising:
a picture detector, operable to detect, for each group of pictures, the inter-encoded pictures within the video sequence;
an extractor, operable to extract the compressed image block data from the detected inter-encoded pictures;
a decompressor, operable to decompress the extracted compressed image block data to recreate the original image blocks; and
a picture generator, operable to replace the replacement image blocks and the compressed image block data with the original image blocks, wherein
the replacement image blocks each have a motion vector of value zero and a difference signal of value zero.

15. An apparatus for reversing modifications made to a compression encoded video sequence according to claim 14, comprising a decryptor for decrypting the compressed image block data.

16. An apparatus for reversing modifications made to a compression encoded video sequence according to claim 14, comprising a watermark decoder for removing a visible watermark from one or more intra-encoded pictures of the video sequence to restore the original intra-encoded pictures.

17. A video sequence distribution system comprising a server apparatus and a client apparatus, the server apparatus being operable
to provide to the client apparatus a modified compression encoded video sequence; and
to provide the client apparatus with information for reversing the modifications made to the modified compression encoded video sequence, wherein the compression encoded video sequence includes groups of pictures comprising an intra-encoded picture and at least one inter-encoded picture, the inter-encoded picture comprising a plurality of image blocks, at least one of the image blocks having a motion vector representing a displacement of the image block with respect to a reference image block in another picture in the group of pictures, and a difference signal representing a difference between the image block and the reference image block, the compression encoded video sequence having been modified by
detecting, for each group of pictures, the inter-encoded pictures within the group of pictures;
extracting the image blocks from the detected inter-encoded pictures;
compressing at least a portion of the extracted image blocks to form compressed image block data; and
inserting replacement image blocks and the compressed image block data into the video sequence to replace the extracted image blocks, wherein
the replacement image blocks each have a motion vector of value zero and a difference signal of value zero.

18. A video sequence distribution system according to claim 17, wherein the client apparatus is operable
to request from the server apparatus the information for reversing the modifications made to the modified compression encoded video sequence; and
to reverse the modifications made to the modified compression encoded video sequence, the reversing of the modifications to the modified compression encoded video sequence being
detecting, for each group of pictures, the inter-encoded pictures within the video sequence;
extracting the compressed image block data from the detected inter-encoded pictures;
decompressing the extracted compressed image block data to recreate the original image blocks; and
replacing the replacement image blocks and the compressed image block data with the original image blocks, wherein
the replacement image blocks each have a motion vector of value zero and a difference signal of value zero.

19. A computer program providing computer executable instructions, which when loaded onto a computer performs a method of modifying a compression encoded video sequence representing a video image, the compression encoded video sequence including groups of pictures comprising an intra-encoded picture and at least one inter-encoded picture, the inter-encoded picture comprising a plurality of image blocks, at least one of the image blocks having a motion vector representing a displacement of the image block with respect to a reference image block in another picture in the group of pictures, and a difference signal representing a difference between the image block and the reference image block, the method comprising
detecting, for each group of pictures, the inter-encoded pictures within the group of pictures;
extracting the image blocks from the detected inter-encoded pictures;
compressing at least a portion of the extracted image blocks to form compressed image block data; and
inserting replacement image blocks and the compressed image block data into the video sequence to replace the extracted image blocks, wherein
the replacement image blocks each have a motion vector of value zero and a difference signal of value zero.

20. A computer program providing computer executable instructions, which when loaded onto a computer performs a method of reversing modifications made to a modified compression encoded video sequence representing a video image, the compression encoded video sequence including groups of pictures comprising an intra-encoded picture and at least one inter-encoded picture, the inter-encoded picture comprising a plurality of image blocks, at least one of the image blocks having a motion vector representing a displacement of the image block with respect to a reference image block in another picture in the group of pictures, and a difference signal representing a difference between the image block and the reference image block, the modified video sequence having therein replacement image blocks and compressed image block data formed from original image blocks, the method comprising the steps of:
detecting, for each group of pictures, the inter-encoded pictures within the video sequence;
extracting the compressed image block data from the detected inter-encoded pictures;
decompressing the extracted compressed image block data to recreate the original image blocks; and
replacing the replacement image blocks and the compressed image block data with the original image blocks, wherein
the replacement image blocks each have a motion vector of value zero and a difference signal of value zero.

21. A data carrier bearing a representation of the computer program as claimed in claim 19.

22. An information signal representing data modified in accordance with the method of claim 1.

23. An information medium bearing an information signal according to claim 21.
